(19) United States
(12) Patent Application Publication
(10) Pub. No.: US 2024/0198821 A1
(43) Pub. Date: Jun. 20, 2024

(54) SYSTEM AND METHOD FOR A CONDUCTIVE CHARGING SYSTEM

(71) Applicant: Proterra Operating Company, Inc., Burlingame, CA (US)

(72) Inventor: Roger INNES, Asheville, NC (US)

(73) Assignee: Proterra Operating Company, Inc., Burlingame, CA (US)

(21) Appl. No.: 18/066,211

(22) Filed: Dec. 14, 2022

(51) Int. Cl. B60L 53/16; B60L 53/35; B60L 53/66; H02J 7/00

(52) U.S. Cl. CPC B60L 53/16; B60L 53/35; B60L 53/66; H02J 7/0013; H02J 7/00308

(57) ABSTRACT

A charging system including a charger, a plurality of charging connectors, one or more electrical connections from the charger to one or more contact elements of each of the plurality of charging connectors, and one or more controllers. Each of the one or more controllers is communicatively coupled to one or more charging connectors of the plurality of charging connectors. A communication controller can be communicatively coupled to the one or more controllers. The communication controller is configured to establish a communication connection with a controller of an electric vehicle of a plurality of electric vehicles; receive, from the controller and based on establishing the communication connection, a request for deployment of a charging connector of the plurality of charging connectors to charge the electric vehicle; determine a deployment state of each of the plurality of charging connectors; and perform one or more actions related to sequential charging.

### TECHNICAL FIELD

Embodiments of this disclosure relate to a charging system and, more particularly, to a charging system that includes multiple charging connectors for a charger.

### BACKGROUND

Electric vehicles, such as electric busses, can be charged using a variety of types of charging systems. For example, these charging systems may use a pin/socket-type connection, a pantograph/electrical line-type connection, a plug/socket-type connection, and/or the like to provide power from the charging system to the electric vehicle. Typically, the charging systems include a single connector to provide power to a single electric vehicle at a time, making it inefficient and time consuming to manage charging of multiple electric vehicles. Currently, an electric vehicle in a charging position has to leave the charging position and the next electric vehicle moved into the charging position in order to sequentially charge multiple electric vehicles. In addition, the power supply of a DC conductive charging system may be expensive. Thus, charging multiple electric vehicles using multiple chargers and multiple connectors may be prohibitively expensive.

A charging system could be configured with isolated controls and high voltage connections to a charger in order to facilitate charging of multiple electric vehicles. However, this configuration may have to use relay(s) or have separate low voltage controls for the connections and may have to use a high voltage connection with relay(s)/contactor(s) to isolate the different charging connectors from the charger. Embodiments of the current disclosure may address these limitations and/or other problems in the art.

### SUMMARY

Embodiments of the present disclosure relate to, among other things, a charging system for electric vehicles. Each of the embodiments disclosed herein may include one or more of the features described in connection with any of the other disclosed embodiments.

Embodiments of the present disclosure relate to, among other things, a charging system for electric vehicles. Each of the embodiments disclosed herein may include one or more of the features described in connection with any of the other disclosed embodiments.

In some aspects, a charging system can include a charger, a plurality of charging connectors, one or more electrical connections from the charger to one or more contact elements of each of the plurality of charging connectors, and one or more controllers. Each of the one or more controllers can be communicatively coupled to one or more charging connectors of the plurality of charging connectors. A communication controller communicatively can be coupled to the one or more controllers. The communication controller can be configured to establish a communication connection with a controller of an electric vehicle of a plurality of electric vehicles; receive, from the controller and based on establishing the communication connection, a request for deployment of a charging connector of the plurality of charging connectors to charge the electric vehicle; determine a deployment state of each of the plurality of charging connectors; and perform one or more actions related to sequential charging of the plurality of electric vehicles based on the deployment state of the each of the plurality of charging connectors.

In some aspects, the one or more controllers are one or more position controllers.

In some aspects, the one or more position controllers and the communication controller are subcontrollers of a single integrated controller.

In some aspects, the communication controller is configured to determine a position of the plurality of charging connectors.

In some aspects, the communication controller is further configured to manage the sequential charging based on one or more safety limitations.

In some aspects, the one or more safety limitations include a voltage limitation for a height of the plurality of charging connectors off of a working surface, and wherein where access is controlled to a plurality of charging connectors.

In some aspects, the communication controller is further configured to manage access to the plurality of charging connectors.

In some aspects, the deployment state includes a first state where a charging connector is in an extended position for charging the electric vehicle or a second state where the charging connector is in a retracted position.

In some aspects, an antenna communicatively can be coupled to the communication controller, wherein the communication controller is further configured to establish the communication connection and receive the request for deployment via the antenna.

In some aspects, the one or more electrical connections include a negative direct current (DC−) electrical connection, and a positive direct current (DC+) electrical connection.

In some aspects, the one or more electrical connections include an alternating current (L1 AC) electrical connection, and an alternating current (L2 or N AC) electrical connection.

In some aspects, the system includes a ground connection from the communication controller to at least one contact element of the one or more contact elements of each of the plurality of charging connectors.

In some aspects, at least one of the plurality of electric vehicles includes an electric bus or a heavy-duty vehicle.

In some aspects, a method is disclosed for sequentially charging a plurality of electric vehicles using an overhead charging system. The method includes establishing, by a communication controller of the overhead charging system, a communication connection with a controller of an electric vehicle of the plurality of electric vehicles at the overhead charging system; receiving, from the controller and based on establishing the communication connection, a request for deployment of a charging connector of a plurality of charging connectors to charge the electric vehicle; determining a deployment state of each of the plurality of charging connectors, wherein the deployment state of each of the plurality of charging connectors includes a charging state or a non-charging state; and performing one or more actions related to sequentially charging the electric vehicle and one or more other electric vehicles of the plurality of electric vehicles based on the deployment state of the each of the plurality of charging connectors.

In some aspects, the overhead charging system includes a charger configured to provide electrical power to the plurality of electric vehicles via the plurality of charging connectors, and one or more position controllers configured to deploy the each of the plurality of charging connectors to each of the plurality of electric vehicles.

In some aspects, the performing of the one or more actions further includes performing the one or more actions based on one or more safety limitations related to charging the plurality of electric vehicles.

In some aspects, the one or more safety limitations include a minimum height of the charging connector above a working surface when the charging connector is in the charging state and operating within a voltage range.

In some aspects, the establishing of the communication connection further includes establishing the communication connection via an antenna communicatively coupled to the communication controller. In some aspects, the establishing of the communication connection can be used in hardwired status and/or locking devices for plugin connections. In some aspects, the receiving of the request for deployment also includes receiving the request for the deployment via the antenna.

In some aspects, a communication controller is disclosed for a charging system including a plurality of pantographs. The communication controller can include at least one memory storing instructions, and at least one processor executing the instructions to perform a method of sequential charging of a plurality of electric vehicles using the charging system. The method can include establishing a communication connection with a controller of an electric vehicle of the plurality of electric vehicles at the charging system; receiving, from the controller of the electric vehicle and based on establishing the communication connection, a request for deployment of a pantograph of the plurality of pantographs to charge the electric vehicle; determining, based on information from one or more position controllers of the charging system, a state of each of the plurality of pantographs; and performing one or more actions related to sequentially charging the electric vehicle and one or more other electric vehicles of the plurality of electric vehicles based on the state of the each of the plurality of pantographs.

In some aspects, the performing of the one or more actions further includes sending a command to a first position controller to keep a first pantograph in a retracted state or in a non-charging state based on a second pantograph being in an extended state or a charging state, and/or sending a command to the first position controller to move the first pantograph to the extended state or the charging state based on the second pantograph being in the retracted state or the non-charging state.

In some aspects, the performing of the one or more actions further includes requesting the information from each of the one or more position controllers, wherein the information indicates the state is a deployment state. The determining of the deployment state further includes determining the deployment state of the each of the plurality of pantographs after requesting the information.

In some aspects, the method performed by the communication controller includes receiving, via an antenna of the controller, the request to establish the communication connection; and wherein the establishing of the communication connection further includes establishing the communication connection after receiving the request via the antenna.

In some aspects, the performing of the one or more actions further includes charging the electric vehicle using a first pantograph based on one or more safety limitations; and charging another electric vehicle using a second pantograph after charging the electric vehicle and based on the one or more safety limitations.

In some aspects, the performing of the one or more actions further includes sending a command to retract the pantograph of the plurality of pantographs that is in an extended state or a charging state for charging the electric vehicle; and disconnecting the communication connection after charging the electric vehicle.

In some aspects, the performing of the one or more actions further includes operating the plurality of pantographs based on one or more safety limitations.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIGS. 1A and 1B illustrate an exemplary electric bus, according to the present disclosure;

FIG. 1C illustrates an exemplary overhead charging system for an electric bus, according to the present disclosure;

FIG. 2 is a schematic illustration of an exemplary charging system for charging the electric bus of FIGS. 1A and 1B, according to the present disclosure;

FIG. 3 is a schematic illustration of an exemplary charging system for charging the electric bus of FIGS. 1A and 1B, according to the present disclosure;

FIG. 4 illustrates an exemplary method of operation of the charging system of FIG. 2 and/or FIG. 3, according to the present disclosure; and

FIG. 5 illustrates example components of a computing device, according to the present disclosure.

### DETAILED DESCRIPTION

The present disclosure describes a system and method for a charging system. While principles of the current disclosure are described with reference to an electric bus, it should be understood that the disclosure is not limited thereto. Rather, the systems and methods of the present disclosure may be used in any vehicle having a battery system (e.g., electric vehicle, electric machine, electric tool, electric appliance, etc.). As used herein, the term “electric vehicle” includes any vehicle or transport machine that is driven at least in part by electricity (e.g., hybrid vehicles, all-electric vehicles, etc.). Heavy duty electric vehicles (e.g., electric buses, electric trucks, electric airplanes, electric boats, etc.) may store and/or consume a large amount of energy compared to smaller electric vehicles (e.g., electric cars, electric bicycles or motorcycles, electric carts, etc.).

In this disclosure, relative terms, such as “about,” “substantially,” or “approximately” are used to indicate a possible variation of ±10% of a stated value.

Any implementation described herein as exemplary is not to be construed as preferred or advantageous over other implementations. Rather, the term “exemplary” is used in the sense of example or illustrative.

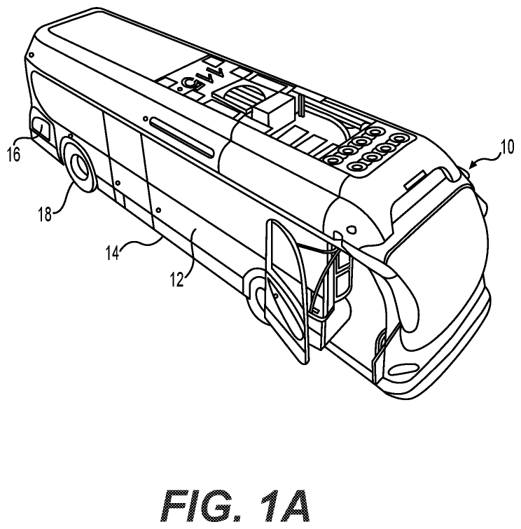

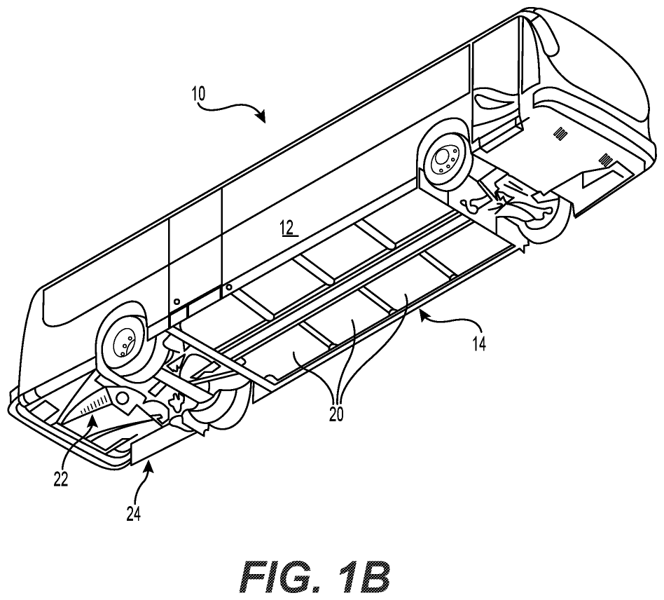

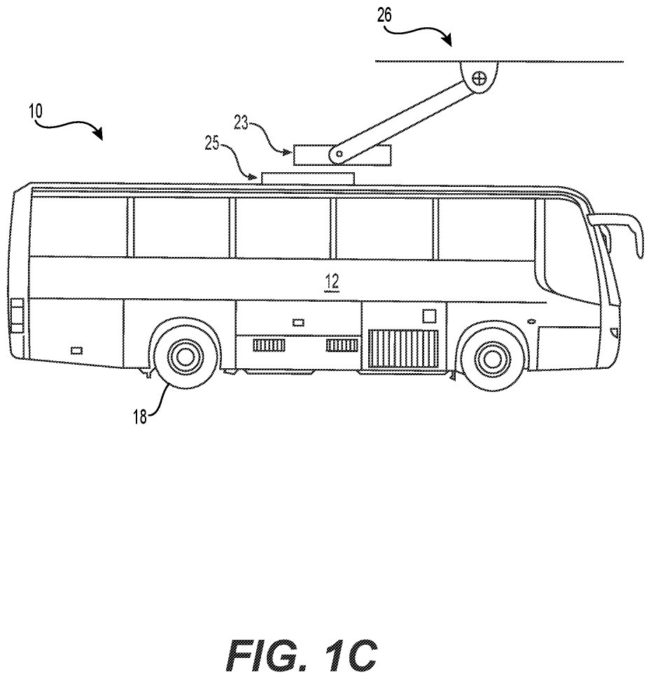

FIGS. 1A and 1B illustrate an electric vehicle in the form of a bus 10. FIG. 1A shows the bus 10 with its roof visible, and FIG. 1B shows the bus 10 with its undercarriage visible. In the discussion below, reference will be made to both FIGS. 1A and 1B. The bus 10 may include a body 12 enclosing a space for passengers. In some embodiments, some (or substantially all) parts of the body 12 may be fabricated using one or more composite materials to reduce the weight of the bus 10. Without limitation, the body 12 of the bus 10 may have any size, shape, and configuration. In some embodiments, the bus 10 may be a low-floor electric bus. In a low-floor electric bus, there may be no stairs at the front and/or the back doors of the bus 10. In such a bus 10, the floor may be positioned close to the road surface to ease of entry into and exit from the bus 10. In some embodiments, the floor height of the low-floor bus may be about 30-45 centimeters from the road surface.

The bus 10 may include a powertrain 24 that propels the bus 10 along a road surface. The powertrain 24 may include one or more electric motors 22 that generate power, and a transmission that transmits the power to a pair of drive wheels (e.g., wheels 18) of the bus 10. A battery system 14 may store electrical energy to power the electric motors 22 of the powertrain 24. In some embodiments, the batteries of the battery system 14 may be configured as a plurality of battery packs 20 positioned in cavities located under the floor of the bus 10. In some embodiments, some or all of the battery packs 20 may be positioned elsewhere (e.g., roof) on the bus 10. The batteries of the battery system 14 may have any chemistry and construction. The battery chemistry and construction may activate fast charging of the batteries. In some embodiments, the batteries may be lithium titanate oxide (LTO) batteries. In some embodiments, the batteries may be nickel metal cobalt oxide (NMC) batteries. It is also contemplated that, in some embodiments, the batteries may include multiple different chemistries.

The bus 10 may include a charging interface. For example, the bus 10 may include a charge port (e.g., an electric socket) that is configured to receive a charging plug and charge the bus 10 using power from a utility grid. In some embodiments, the bus 10 may be charged by connecting the plug from an electrical connection with the utility grid to the socket of the charge port and locking the plug in one or both of the electrical connection with the utility grid or the charge port. In some embodiments, the charge port may be a standardized charge port (e.g., a Society of Automotive Engineers (SAE) J1772 charge port) that is configured to receive a corresponding standardized connector (e.g., a SAE J1772 connector). In some aspects, when using an SAE J1772 connector, SAE J1772 connector can be detected and/or locked to a storage location and/or the vehicle. In some aspects, it is contemplated that bus 10 and the corresponding charging systems can operate and be compatible in accordance with multiple standards (e.g., SAEJ1772 and SAEJ3105).

Use of these standardized charge ports is not limiting, however, and other standardized charge ports are contemplated including but not limited to IEC 62196 Type 2 connectors, CHAdeMO systems, GB/T 20234 family for electric vehicle AC and DC fast-charging, etc. However, in general, the charge port and the mating connector may be of any type and form (custom design or standardized). As illustrated in FIG. 1A, to protect the charge port from the environment (rain, snow, debris, etc.), a hinged lid 16 may cover the charge port when not in use. Additionally, or alternatively, a charging interface may be provided on the roof of the bus 10 (not illustrated in FIGS. 1A and 1B) to charge the batteries of the battery system 14. For example, the charging interface may include components that interface with a charging head of an external charging station to charge the batteries.

By way of example and without limitation, the charging head for a roof-mounted configuration may include an inverted pantograph that interfaces with a set of rails mounted on the forward rooftop of the electric bus 10. As other specific examples, the charging head may include an infrastructure-mounted cross rail head (e.g., according to the SAE J3105/1 standard, which is incorporated herein by reference in its entirety), the charging interface may include a vehicle-mounted pantograph that interfaces with a charging head (e.g., a vehicle-mounted panhead that interfaces with an overhead hood according to the SAE J3105/2 standard, which is incorporated herein by reference in its entirety), or the charging head and charging interface may include a pin and socket connection (e.g., according to the SAE J3105/3 standard, which is incorporated herein by reference in its entirety). Examples of various charging heads and charging interfaces, which may be used with certain embodiments described herein, are described and illustrated in U.S. Pat. Nos. 10,875,411 B2, 11,345,245 B2, and 11, 351,879 B2, which are incorporated herein by reference in their entirety. As an example of an overhead charging system 26 for an electric bus 10, FIG. 1C illustrates an example of a vehicle-mounted panhead 23 that interfaces with an overhead hood 25 of a charging system 26.

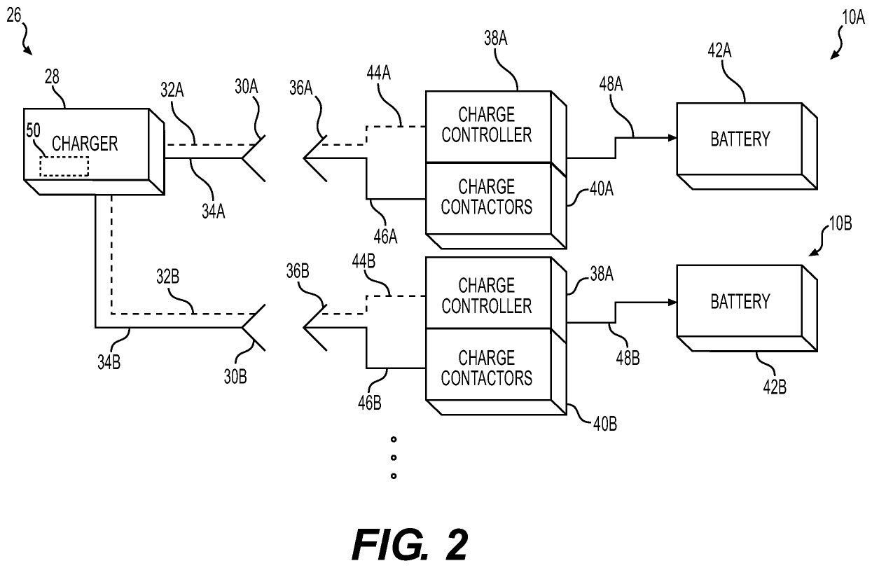

FIG. 2 is a schematic illustration of an exemplary charging system 26 for charging the bus 10 of FIGS. 1A and 1B, according to the present disclosure. As illustrated, the charging system 26 includes a charger 28 and multiple charging connectors 30 (e.g., charging connectors 30A, 30B) of a charging head. As discussed herein, the term “charger” may include a device for conditioning one or multiple power grids (can be local home grip or the power grid) having one or more independent connections for use connecting to vehicle. In some aspects, a conditioning device associated with the charger of this disclosure may be a power supply, one or more contactors, and/or a wire. In some aspects, charger supplied conditioned power for the electric vehicle may have to condition again for use in High Voltage systems.

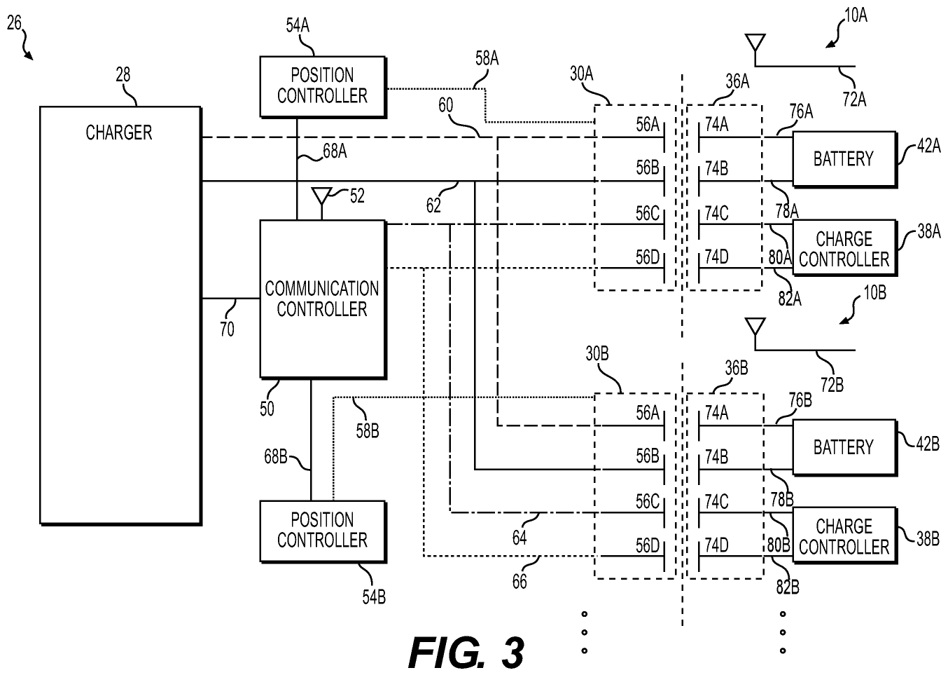

The charging connectors 30 may each be connected to the charger 28 and an associated centralized controller (e.g., communication controller 50, described in more detail with respect to FIG. 3) via various connections, such as a data connection 32 and an electrical connection 34. For example, the charging connector 30A may be communicatively coupled to a controller 50 associated with the charger 28 via the data connection 32A and may be electrically connected to the charger 28 via the electrical connection 34A. It is understood that controller 50 can be split into one or more separate controllers that are wireless and/or wired to individual charging connectors.

The charging connector 30B may be similarly connected to the centralized controller associated with the charger 28 and to the charger 28 via a data connection 32B and an electrical connection 34B. A charging connector 30 may include a pin-type connector, a plug-type connector, a socket-type connector, a cross-rail-type connector, a pantograph-type connector, and/or the like. The electrical connections 34 and the data connections 32 may include wired and/or wireless connections.

FIG. 2 further illustrates various electric busses 10 (e.g., electric bus 10A and electric bus 10B). Each bus 10 may include a charging connector 36 of a charging interface, a data connection 44 to a charge controller 38, an electrical connection 46 to charge contactors 40, and an electrical connection 48 to a battery 42. In some aspects, charge contactors 40 can be a power supply if charger 28 provides AC power. In some aspects, while electric busses 10 of FIG. 2 are shown only connected to one connection (e.g., charger 28) of charging system 26, it is contemplated that in some aspects electric busses 10 can be connected to multiple connections (e.g., charger 28) of charging system 26. A charging connector 30 of the charging system 26 may couple to a charging connector 36 of an electric bus 10 for transferring electrical power to the electrical bus 10 and/or for exchanging data with the electric bus 10. In some embodiments, a charging connector 30 may be mounted on an electromechanical arm or other structure configured to extend to couple the charging connector 30 with a charging connector 36 of the electric bus 10. Additionally, alternatively, the charging connector 36 may be mounted on an electromechanical arm or other structure configured to extend to couple with the charging connector 30.

The charge controller 38 may control charging of the electric bus 10. For example, the charge controller 38 may request deployment and connection of a charging connector 30 when the electric bus 10 moves into a charging position. These and other operations of the charge controller 38 are described elsewhere herein. The charge contactors 40 may allow or prevent input of power into the battery 42. For example, when the electric bus 10 is not being charged, the charge controller 38 may open the charge contactors 40 such that electrical power cannot be provided to the battery 42. Alternatively, in association with the electric bus 10 being charged, the charge controller 38 may close the charge contactors 40 such that electrical power can be provided to the battery 42. In some embodiments, the charge controller 38 and the communication controller 50 may operate according to a standard, such as the SAE J3105 standard (e.g., according to SAE J3105_202001, which is incorporated herein by reference in its entirety).

FIG. 3 is a schematic illustration of an exemplary charging system for charging the bus 10 of FIGS. 1A and 1B, according to the present disclosure. For example, FIG. 3 illustrates additional details of the charging system 26 and the bus 10.

Similar to that illustrated in FIG. 2, the charging system 26 illustrated in FIG. 3 may include a charger 28, multiple charging connectors 30, and a communication controller 50. The communication controller 50 may include an antenna 52, via which the communication controller 50 may send and receive wireless signals, as described in more detail elsewhere herein. The charging system 26 may include multiple position controllers 54 (e.g., position controllers 54A, 54B). In some embodiments, each charging connector 30 may be associated with a position controller 54, as illustrated in FIG. 3. In other embodiments, the charging system 26 may include a single position controller 54 for the multiple charging connectors 30. In addition, in some embodiments, the communication controller 50 and the position controller(s) 54 may be combined into a single controller that can perform the functions of the communication controller 50 and the position controller 54.

The communication controller 50 may be communicatively coupled to the position controller(s) 54 via communication connection(s) 68. For example, the communication controller 50 may be communicatively coupled to the position controller 54A via a communication connection 68A and the communication controller 50 may be communicatively coupled to the position controller 54B via the communication connection 68B. As described in more detail elsewhere herein, the communication controller 50 may send commands to a position controller 54 and/or may receive information related to a deployment state of a charging connector 30 via a communication connection 68. The communication controller 50 may be further communicatively coupled to the charger 28 via a communication connection 70. For example, the communication controller 50 may provide commands to the charger 28 and/or receive information related to operations of the charger 28 via the communication connection 70, as described in more detail elsewhere herein. As described in more detail elsewhere herein, the communication controller 50 may control charging operations in accordance with one or more safety limitations, such as a minimum height above a working surface for a charging voltage range as specified in National Fire Protection Association (NFPA) code 70 § 110.27(A)(4), which is incorporated herein by reference in its entirety.

A position controller 54 may be communicatively coupled to a charging connector 30 via a communication connection 58. For example, the position controller 54A may communicate with the charging connector 30A via the communication connection 58A and the position controller 54B may communicate with the charging connector 30B via the communication connection 58B. As described elsewhere herein, a position controller 54 may send commands to a charging connector 30 and may receive information related to the position of the charging connector 30 from the charging connector 30, via the communication connection 58.

As further illustrated in FIG. 3, a charging connector 30 may include one or more contact elements 56. For example, a contact element 56 may include a pin, a plate, a contact, an electrode, and/or the like. Different contact elements 56 of the charging connector 30 may be connected to different elements of the charging system 26. For example, the charging connector 30 may include a contact element 56A, which may be electrically coupled to the charger 28 via a positive DC (DC+) electrical connection 60. As another example, the charging connector 30 may include a contact element 56B, which may be electrically connected to the charger 28 via a negative DC (DC−) electrical connection 62. The charging system 26 may provide electrical power to a battery 42 of a bus 10 via the DC+ electrical connection 60 (and contact element 56A) and the DC− electrical connection 62 (and the contact element 56B). In some aspects, connections 60 and 62 can be directly connected to one or multiple charging connectors 30 to control and/or detect status of a respective charging connector 30.

As another example, the charging connector 30 may include a contact element 56C connected to the communication controller 50 via an equipment ground connection 64. For example, the equipment ground connection 64 may include a protective earth (PE) connection. As another example, the charging connector 30 may include a contact element 56D communicatively coupled to the communication controller 50 via a communication connection 66. For example, the communication connection 66 may include a control pilot (CP) connection. In some aspects, communication connection 66 along with a return of equipment ground connection 64 can be directly connected to one or multiple charging connectors 30 to control and/or detect status of a respective charging connector 30. As further illustrated in FIG. 3, electric busses 10 (e.g., electric busses 10A and 10B) may be connected to the charging system 26. For example, the electric bus 10A may be connected to the charging system 26 based on the charging connector 36A of the electric bus 10A being coupled with the charging connector 30A of the charging system 26. The electric bus 10B may be connected to the charging system 26 in a similar manner as the electric bus 10A.

As further illustrated in FIG. 3, a charging connector 36 may include one or more contact elements 74, which may be similar to the contact elements 56. In some embodiments, the charging connector 36 may include corresponding contact elements 74 for the contact elements 56. For example, a charging connector 36 may include a contact element 74A corresponding to the contact element 56A, a contact element 74B corresponding to the contact element 56B, a contact element 74C corresponding to the contact element 56C, and a contact element 74D corresponding to a contact element 56D. The contact element 74A may be electrically coupled to a battery 42 via a DC+ electrical connection 76 and a DC− electrical connection 78 (e.g., a DC+ electrical connection 76A and a DC− electrical connection 78A in the electric bus 10A and a DC+ electrical connection 76B and a DC− electrical connection 78B in the electric bus 10B). In some aspects, DC− electrical connection 78A can include one or more contactors. In aspects where AC charging is contemplated with the system of FIG. 3, a power supply on the vehicle can be provided. Whether via AC or DC power (e.g., in aspects that contemplate High Voltage systems such as 400 hz AC), bidirectional power flow can be provided between vehicle-side and infrastructure-side connections.

For example, power from the charging system 26 may be provided to the battery 42 to charge the battery 42. In some aspects, power from the charging system 26 can be provided to a High Voltage system of the electric bus 10A. The contact element 74C may be connected to an equipment ground connection 80 (e.g., equipment ground connection 80A for the electric bus 10A and equipment ground connection 80B for the electric bus 10B). The contact element 74D may be communicatively coupled to a charge controller 38A via a communication connection 82 (e.g., a communication connection 82A for the electric bus 10A and a communication connection 82B for the electric bus 10B).

As further illustrated in FIG. 3, an electric bus 10 may include an antenna 72. For example, the electric bus 10A may include an antenna 72A and the electric bus 10B may include an antenna 72B. In some embodiments, an electric bus 10 may communicate with the charging system 26 using the antenna 72, as described in more detail elsewhere herein. For example, the electric bus 10 may send wireless signals to the communication controller 50 via the antenna 72 and/or may receive wireless signals from the communication controller 50 via the antenna 72. In some aspects, the antenna 72 can establish a communication connection via an antenna 52, which can be associated with the communication controller 50. In some aspects, the communications controller 50 can include separate controllers to communicate and/or manage antennas 52 and/or 72. In some aspects, the communications controller 50 may connect to a separate controllers that handle contact elements 56C, 56D, etc., for each respective charging connector 30.

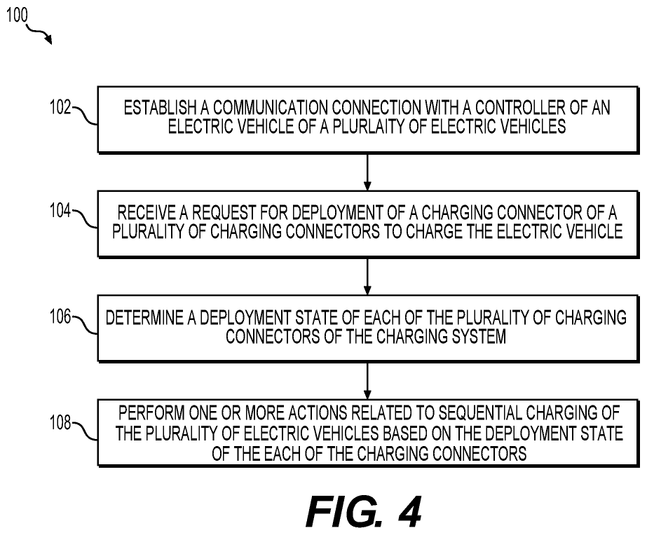

FIG. 4 illustrates an exemplary method 100 of operation of the charging system 26 of FIG. 2 and/or FIG. 3, according to the present disclosure. Although the method 100 is described as being performed by a communication controller 50, in some embodiments a position controller 54 and/or another element of the charging system 26 may perform the method 100 (or portions of the method 100). In some embodiments, a combination of the communication controller 50 and the position controller 54 may perform the method 100. For example, the communication controller 50 may perform the operations illustrated at 102 and 104 and the position controller 54 may perform the operations illustrated at 106 and 108.

The method 100 may include, at operation 102, establishing a communication connection with a controller of an electric vehicle of a plurality of electric vehicles. For example, a communication controller 50 may establish a communication connection with a charge controller 38 of an electric bus 10 of a plurality of electric busses 10. The communication controller 50 may establish a communication connection via an antenna 52 associated with the communication controller 50. For example, the communication controller 50 may establish a wireless communication connection by sending wireless signals to an antenna 72 of the electric bus 10 and/or receiving wireless signals (e.g., wireless signals according to the IEEE 802.11n-2009 or 802.11n standard) from the antenna 72 of the electric bus 10.

The communication controller 50 may establish the communication connection based on the electric bus 10 being in a charging position. For example, the electric bus 10 may enter a charging depot associated with a charging system 26, and may enter the charging position by entering a charging bay, a parking spot, a queue position, and/or the like proximate to a charging connector 30. Continuing with the previous example, the electric bus 10 may send a wireless signal to the communication controller 50 indicating that the electric bus 10 is in the charging position when the electric bus 10 enters the charging position. Additionally, or alternatively, the communication controller 50 may detect that the electric bus 10 is in the charging position based on one or more sensors (e.g., ultrasonic, GPS, infrared, radar, lidar, sonar, and/or other type of sensor capable of sending and receiving a signal to determine the position of an object in the space surrounding the sensor, etc.) detecting the positioning of the electric bus 10. Additionally, or alternatively, the communication controller 50 may establish the communication connection based on an operator of the charging system 26 inputting a command to establish the communication connection.

The method 100 may include, at operation 104, receiving a request for deployment of a charging connector of a plurality of charging connectors to charge the electric vehicle. For example, the communication controller 50 may receive a request for deployment of a charging connector 30 of a plurality of charging connectors 30 to charge the electric bus 10. The communication controller 50 may receive the request from the charge controller 38. The communication controller 50 may receive request via an antenna 52 associated with the communication controller 50. For example, an electric bus 10 may send the request to the communication controller 50 as a wireless signal via an antenna 72 associated with the electric bus 10.

The communication controller 50 may receive the request automatically after the communication controller 50 establishes the communication connection with the charge controller 38. For example, the charge controller 38 may detect that the communication connection has been established and may send the request to the communication controller 50 based on detecting that the communication connection has been established. Alternatively, the communication controller 50 may receive the request after sending an indication to the charge controller 38 that the communication controller 50 is available for communication. For example, after establishing the communication connection, the communication controller 50 may send an indication to the charge controller 38 of the electric bus 10 that the communication connection is established and may then receive the request after sending the indication.

As illustrated at operation 106, the method 100 may include determining a deployment state of each of the plurality of charging connectors of the charging system. For example, the communication controller 50 may determine the deployment state of each of the plurality of charging connectors 30 of the charging system 26. The communication controller 50 may determine the deployment state after receiving the request. For example, the communication controller 50 may determine the deployment state automatically, at a scheduled time or after a pre-determined delay after receiving the request, based on input from an operator of the charging system 26, and/or the like.

The communication controller 50 may determine the deployment state of a charging connector 30 based on information from a position controller 54 associated with the charging connector 30 that indicates the deployment state. For example, the communication controller 50 may send a request for the information indicating the deployment state to the position controller 54 and may receive the information from the position controller 54 after sending the request for the information. Additionally, or alternatively, and as another example, the communication controller 50 may receive periodic updates from a position controller 54 regarding the deployment state of a charging connector 30, may store the updates in a data store, and may determine the deployment state based on the information in the data store.

The deployment state may include a first state associated with charging the electric bus 10. For example, the deployment state may include an extended state (e.g., extended position) or a charging state where an electromechanical arm associated with the charging connector 30 is extended to connect to a charging connector 36 and/or coupled with a charging connector 36. Additionally, or alternatively, the deployment state may include a second state associated with not charging the electric bus 10. For example, the deployment state may include a retracted state (e.g., retracted position) or a non-charging state where the electromechanical arm associated with the charging connector 30 is retracted from connecting to the charging connector 36 and/or is not coupled with a charging connector 36. One or more other states may be possible according to some embodiments, such as a transitional state where the electromechanical arm is neither fully extended nor fully retracted or a state where a charging connector 30 is coupled to a charging connector 36 but charge contactors 40 are open.

As illustrated at operation 108, the method 100 may include performing one or more actions related to sequential charging of the plurality of electric vehicles based on the deployment state of the each of the charging connectors. For example, the communication controller 50 may perform one or more actions related to sequential charging of the plurality of electric vehicles 10 based on the deployment state of the each of the charging connectors 30. In some aspects, such as with SAE J1772 connectors and/or charge ports, the one or more actions can include sensing the charging station and based on such sensing, open a respective contactor. The communication controller 50 may perform the one or more actions automatically after determining the deployment states of the charging connectors 30, at a scheduled time after determining the deployment states, based on user input to perform the one or more actions, based on a location of the charging system 26 (e.g., certain bus operators may have priority charging in certain locations), based on demand billing rates (e.g., certain electric buses 10 may be billed at a higher rate than other electric buses 10), based on configurations of the electric buses 10 and/or associated batteries (e.g., electric buses 10 with more depleted batteries may be charged before other electric buses 10 with less depleted batteries, electric buses 10 with a shorter range may be charged before electric buses 10 with a longer range, plug-in interfaces such as SAE J1772 connectors and/or charge ports, etc.), an order of arrival of the electric buses 10 at the charging system 26 (e.g., the electric buses 10 may be charged in a first-in-first-out manner), a schedule of the electric buses 10 (e.g., electric buses 10 that are to return to service after charging may be charged before electric buses 10 that are to stay at a depot after charging), and/or the like.

The one or more actions may include, e.g., charging a first electric bus 10 using a first charging connector 30 while not charging one or more other electric buses 10 at the charging system 26. After charging the first electric bus 10, the charging system 26 may charge a second electric bus 10, e.g., using a second charging connector 30. Additionally, or alternatively, the one or more actions may include, e.g., sending a command to various position controllers 54. For example, the communication controller 50 may send a command to a first position controller 54 to keep a first charging connector 30 in a retracted state or a non-charging state based on a second charging connector 30 being in an extended state or a charging state. Similarly, and as another example, the communication controller 50 may send a command to the first position controller 54 to move to an extended state or a charging state based on the second charging connector 30 being in a retracted state or a non-charging state (or based on sending a command to the second charging connector 30 to move to the retracted state or the non-charging state).

When the communication controller 50 sends a command to move a charging connector 30 into a retracted state from an extended state (e.g., after a charging event is complete), the communication controller 50 may disconnect an established connection with an electric bus 10. Similarly, the communication controller 50 may establish a communication connection with an electric bus 10 prior to sending a command to a charging connector 30 to extend to charge the electric bus 10.

The communication controller 50 may perform the one or more actions based on one or more safety limitations. For example, the one or more safety limitations may be related to charging the plurality of electric busses 10 and may restrict certain operations from being performed at certain times. As a specific example, the one or more safety limitations may include a voltage limitation for a height of an electrical wire or a charging connector 30 off of a roof of an electric bus 10 and/or a working surface (e.g., the ground, a raised platform, and/or the like), such as voltage and height limitations described in NFPA code 70 § 110.27(A)(4). Continuing with the specific example, the safety limitations may prevent a charging connector 30 from being below a height limit when charging an electric bus 10 (e.g., NFPA code 70 § 110.27(A)(4) specifies a minimum height of 2.5 meters (m) above a working surface for 50V to 300V between ungrounded conductors, a minimum height of 2.6 m for 301V to 600V, and a minimum height of 2.62 m for 601V to 1000V). The safety limitations may also include a rated enclosure, such as with SAE J1772 charging systems. Based on this, the communication controller 50 may confirm, from a sensor, a height of the charging connector 30 prior to sending a command to provide power to the charging connector 30. In this way, the communication controller 50 may manage sequential charging of electric busses 10.

Although the method 100 is described as including certain aspects, other embodiments may include different aspects. For example, for the operation at 102, the electric bus 10 may establish the communication connection rather than the charging system 26 establishing the communication connection. Additionally, or alternatively, for the operation at 104, the electric bus 10 may be configured with a movable charging connector 36, and the electric bus 10 may send a request for permission to deploy the charging connector 36 rather than sending a request for deployment of a charging connector 30 of the charging system 26. Similarly, the electric bus 10 may determine the deployment state at operation 106, such as in the case where the electric bus 10 has a movable charging connector 36.

In this way, certain embodiments described herein may provide various technological advantages or improvements. For instance, certain embodiments may efficiently manage sequential charging of multiple electric vehicles, which may reduce an amount of time for charging the electric vehicles. In addition, certain embodiments may automatically perform charging operations based on safety limitations, which may improve safety at a charging depot. Furthermore, by using a charging system that includes one charger and multiple charging connectors, certain embodiments may reduce or eliminate a need for multiple chargers. This may reduce a spatial footprint and/or a cost of the charging system.

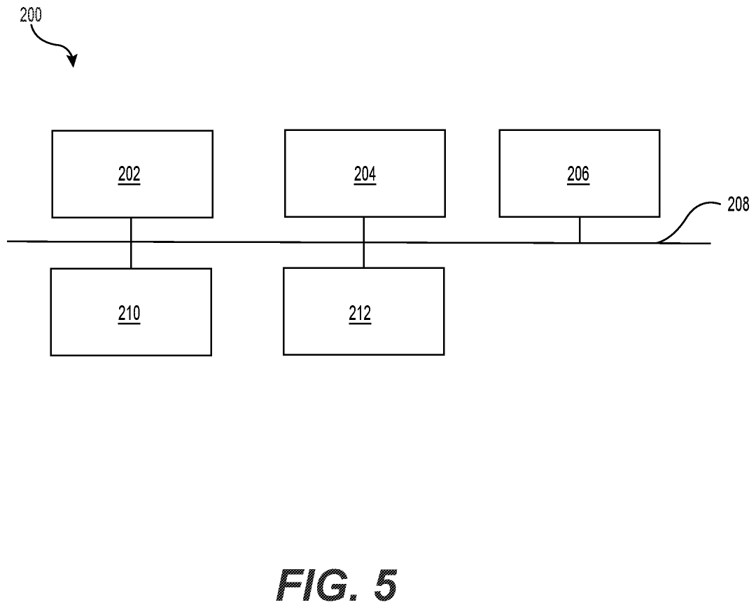

FIG. 5 illustrates example components of a computing device 200, according to the present disclosure. In particular, FIG. 5 is a simplified functional block diagram of a computing device 200 that may be configured as a device for executing a method of this disclosure, such as the method 100 of FIG. 4. For example, the computing device 200 may be configured as a charge controller 38, a communication controller 50, a position controller 54, and/or another device or system according to exemplary embodiments of the present disclosure. In various embodiments, any of the devices or systems described herein may be the computing device 200 illustrated in FIG. 5 and/or may include one or more of the computing devices 200.

As illustrated in FIG. 5, the computing device 200 may include a processor 202, a memory 204, an output component 206, a communication bus 208, an input component 210, and a communication interface 212. The processor 202 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the processor 202 includes one or more processors capable of being programmed to perform a function. The memory 204 may include a random access memory (RAM), a read only memory (ROM), and/or another type of dynamic or static storage device (e.g., a flash memory, a magnetic memory, and/or an optical memory) that stores information and/or instructions for use by the processor 202.

The output component 206 may include a component that provides output information from the computing device 200 (e.g., a display, a speaker, and/or one or more light-emitting diodes (LEDs)). The communication bus 208 may include a component that permits communication among the components of the computing device 200. The input component 210 may include a component that permits the computing device 200 to receive information, such as via user input (e.g., a touch screen display, a keyboard, a keypad, a mouse, a button, a switch, and/or a microphone). Additionally, or alternatively, the input component 210 may include a sensor for sensing information (e.g., a global positioning system (GPS) component, an accelerometer, a gyroscope, and/or an actuator). The communication interface 212 may include a transceiver-like component (e.g., a transceiver and/or a separate receiver and transmitter) that activates device 200 to communicate with other devices, such as via a wired connection, a wireless connection, or a combination of wired and wireless connections. The communication interface 212 may permit the computing device 200 to receive information from another device and/or provide information to another device. For example, the communication interface 212 may include a controller area network (CAN) bus, an Ethernet interface, an optical interface, a coaxial interface, an infrared interface, a radio frequency (RF) interface, a universal serial bus (USB) interface, a wireless local area network interface, a cellular network interface, and/or the like.

As noted above, the computing device 200 illustrated in FIG. 5 may perform one or more processes described herein. The computing device 200 may perform these processes based on the processor 202 executing software instructions stored by a non-transitory computer-readable medium, such as the memory 204 and/or another storage component. For example, the storage component may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. A computer-readable medium is defined herein as a non-transitory memory device. A memory device includes memory space within a single physical storage device or memory space spread across multiple physical storage devices.

Software instructions may be read into the memory 204 and/or a storage component from another computer-readable medium or from another device via the communication interface 212. When executed, software instructions stored in the memory 204 and/or the storage component may cause the processor 202 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

While principles of the present disclosure are described herein with reference to a charging system that includes charging connectors for electric buses, it should be understood that the disclosure is not limited thereto. Rather, the systems and methods described herein may be employed in any type of electric vehicle. Also, those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description. For example, while certain features have been described in connection with various embodiments, it is to be understood that any feature described in conjunction with any embodiment disclosed herein may be used with any other embodiment disclosed herein.

What is claimed:

1. A charging system, comprising:
a charger;
a plurality of charging connectors;
one or more electrical connections from the charger to one or more contact elements of each of the plurality of charging connectors;
one or more controllers, wherein each of the one or more controllers is communicatively coupled to one or more charging connectors of the plurality of charging connectors; and
a communication controller communicatively coupled to the one or more controllers,
wherein the communication controller is configured to:
establish a communication connection with a controller of an electric vehicle of a plurality of electric vehicles;
receive, from the controller and based on establishing the communication connection, a request for deployment of a charging connector of the plurality of charging connectors to charge the electric vehicle;
determine a deployment state of each of the plurality of charging connectors; and
perform one or more actions related to sequential charging of the plurality of electric vehicles based on the deployment state of the each of the plurality of charging connectors.

2. The charging system of claim 1, wherein the one or more controllers are one or more position controllers.

3. The charging system of claim 2, wherein the one or more position controllers and the communication controller are subcontrollers of a single integrated controller.

4. The charging system of claim 1, wherein the communication controller is further configured to manage the sequential charging based on one or more safety limitations.

5. The charging system of claim 4, wherein the one or more safety limitations comprise a voltage limitation for a height of the plurality of charging connectors off of a working surface, and wherein where access is controlled to a plurality of charging connectors.

6. The charging system of claim 4, wherein the communication controller is further configured to manage access to the plurality of charging connectors.

7. The charging system of claim 1, wherein the deployment state comprises a first state where a charging connector is in an extended position for charging the electric vehicle or a second state where the charging connector is in a retracted position.

8. The charging system of claim 1, wherein the one or more electrical connections comprise:
a negative direct current (DC−) electrical connection, and
a positive direct current (DC+) electrical connection.

9. The charging system of claim 1, wherein the one or more electrical connections comprise:
an alternating current (L1 AC) electrical connection, and
an alternating current (L2 or N AC) electrical connection.

10. A method of sequentially charging a plurality of electric vehicles using an overhead charging system, the method comprising:
establishing, by a communication controller of the overhead charging system, a communication connection with a controller of an electric vehicle of the plurality of electric vehicles at the overhead charging system;
receiving, from the controller and based on establishing the communication connection, a request for deployment of a charging connector of a plurality of charging connectors to charge the electric vehicle;
determining a deployment state of each of the plurality of charging connectors, wherein the deployment state of each of the plurality of charging connectors comprises a charging state or a non-charging state; and
performing one or more actions related to sequentially charging the electric vehicle and one or more other electric vehicles of the plurality of electric vehicles based on the deployment state of the each of the plurality of charging connectors.

11. The method of claim 10, wherein the overhead charging system further comprises:
a charger configured to provide electrical power to the plurality of electric vehicles via the plurality of charging connectors, and
one or more position controllers configured to deploy the each of the plurality of charging connectors to each of the plurality of electric vehicles.

12. The method of claim 10, wherein the performing of the one or more actions further comprises:
performing the one or more actions based on one or more safety limitations related to charging the plurality of electric vehicles.

13. The method of claim 10, wherein the establishing of the communication connection further comprises:
establishing the communication connection via an antenna communicatively coupled to the communication controller; and
wherein the receiving of the request for deployment further comprises:
receiving the request for the deployment via the antenna.

14. A communication controller of a charging system including a plurality of pantographs, comprising:
at least one memory storing instructions; and
at least one processor executing the instructions to perform a method of sequential charging of a plurality of electric vehicles using the charging system, the method comprising:
establishing a communication connection with a controller of an electric vehicle of the plurality of electric vehicles at the charging system;
receiving, from the controller of the electric vehicle and based on establishing the communication connection, a request for deployment of a pantograph of the plurality of pantographs to charge the electric vehicle;
determining, based on information from one or more position controllers of the charging system, a state of each of the plurality of pantographs; and
performing one or more actions related to sequentially charging the electric vehicle and one or more other electric vehicles of the plurality of electric vehicles based on the state of the each of the plurality of pantographs.

15. The communication controller of claim 14, wherein the performing of the one or more actions further comprises:
sending a command to a first position controller to keep a first pantograph in a retracted state or in a non-charging state based on a second pantograph being in an extended state or a charging state, and/or
sending a command to the first position controller to move the first pantograph to the extended state or the charging state based on the second pantograph being in the retracted state or the non-charging state.

16. The communication controller of claim 14, wherein the performing of the one or more actions further comprises:
requesting the information from each of the one or more position controllers, wherein the information indicates the state is a deployment state; and
wherein the determining of the state further comprises:
determining the deployment state of the each of the plurality of pantographs after requesting the information.

17. The communication controller of claim 14, further comprising:
receiving, via an antenna of the controller, the request to establish the communication connection; and
wherein the establishing of the communication connection further comprises:
establishing the communication connection after receiving the request via the antenna.

18. The communication controller of claim 14, wherein the performing of the one or more actions further comprises:
charging the electric vehicle using a first pantograph based on one or more safety limitations; and
charging another electric vehicle using a second pantograph after charging the electric vehicle and based on the one or more safety limitations.

19. The communication controller of claim 14, wherein the performing of the one or more actions further comprises:
sending a command to retract the pantograph of the plurality of pantographs that is in an extended state or a charging state for charging the electric vehicle; and
disconnecting the communication connection after charging the electric vehicle.

20. The communication controller of claim 14, wherein the performing of the one or more actions further comprises:
operating the plurality of pantographs based on one or more safety limitations.
